(19) United States
(12) Patent Application Publication
(10) Pub. No.: US 2004/0139110 A1
(43) Pub. Date: Jul. 15, 2004

(54) Sensor network control and calibration system

(76) Inventors: Anthony G. LaMarca, Seattle, WA (US); Gaetano Borriello, Seattle, WA (US)

Correspondence Address: Robert A. Burtzlaff, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/334,567

(22) Filed: Dec. 31, 2002

(51) Int. Cl. G06F 7/00

(52) U.S. Cl. 707/104.1

(57) ABSTRACT

In one embodiment a software control system supports sensor control services, robotic control services, and database management services on at least two independent software systems. Available services are registerable between one or more services using communication between the services via messages not guaranteed to be delivered.

### FIELD OF THE INVENTION

The present invention relates to control of sensor networks.

### BACKGROUND

Reliable control of heterogeneous systems that include autonomous or semi-autonomous mobile robotic units, units with high data rate video or acoustic sensors, units in intermittent low power/low data rate connection, and fixed servers or network accessible computing systems can be difficult. Given the widely differing data transfer rates, data latencies, and response urgency for such disparate systems, ensuring consistent state changes and the necessary control response presents many problems.

Such problems are particularly acute for sensor networks increasingly being deployed to support home and office automation by passing data to and from remote sensor units. Sensors are prone to both long term failures (e.g. calibration failures), intermittent failures (e.g. blocking of a video camera by an object moved in front of the camera, or temporary power loss to the sensor). Maintaining information about sensor status, distinguishing long term or intermittent failure modes, and providing for necessary service can be costly in computational resources and manpower.

In addition, most sensor network applications currently have viability problems related to deployment, security, calibration, failure detection and power management. Sensors must be calibrated, positioned, powered, and replaced when defective. While small numbers of hard wired sensors or wireless sensors can be manually maintained, such human intensive methods are costly when hundreds of widely distributed sensors must be maintained.

### DESCRIPTION OF THE DRAWINGS

The inventions will be understood more fully from the detailed description given below and from the accompanying drawings of embodiments of the inventions which, however, should not be taken to limit the inventions to the specific embodiments described, but are for explanation and understanding only.

FIG. 1 schematically illustrates a robotically maintained and calibrated sensor system;

FIG. 2 illustrates software components controlling a robotically maintained and calibrated sensor system; and

FIG. 3 illustrates operation of robotic and sensor platforms under control of a system that support robotic calibration.

### DETAILED DESCRIPTION

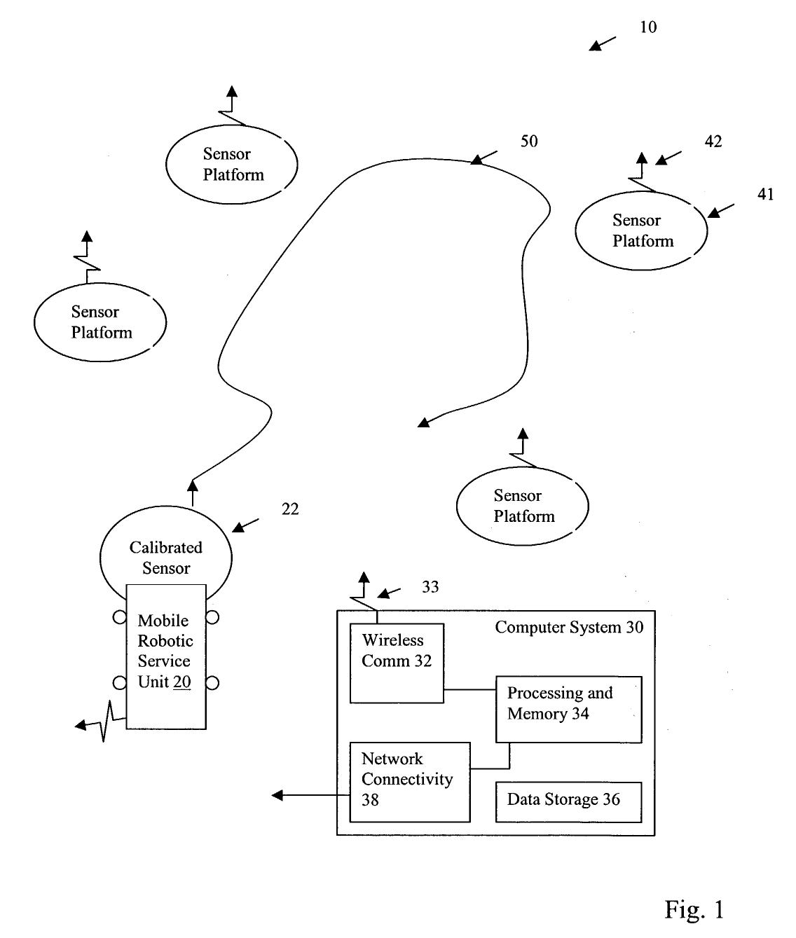

As illustrated in FIG. 1, sensor calibration system 10 includes a mobile robotic service unit 20 having an associated calibrated sensor 22. The robotic service unit 20 is capable of maneuvering (e.g. by path 50) around the environment to respective positions adjacent to various sensor platforms 41, and supports autonomous, semi-autonomous, or guided identification of sensor location for sensors distributed in an environment. Both the robotic service unit and the sensor platforms 41, which may include, for example, sensors for detecting temperature, water level, relative humidity, luminance, or vibration, are connected by wireless or wired links 42, to a computer system 30. The computer system 30 accordingly has processing and memory 34, along with data storage 36, to process information developed or associated with the sensor platforms and mobile robotic service unit, the information being received through wireless communication module 32 or via a wired network connection 38. Cooperation between the robotic service unit 20, sensor platforms 41, and computer system 30 permits operation of the robotic service unit 20 to calibrate sensors on the sensor platforms with respect to one or more calibrated sensors mounted on the robotic service unit.

In certain embodiments, such calibration can utilize information contained in a persistent calibration database (associated with either the mobile robotic unit, the sensor platforms, the computing system, or some distributed combination thereof); and set of calibration algorithms to monitor long term trends, determine failure modes, and provide preventative sensor platform maintenance. For example, when a reading is received from a sensor platform, a lookup with the sensor's unique identification is performed on a calibration database. The calibration data, along with the sensor reading, is fed into suitable calibration algorithms. The algorithms either produce an adjusted sensor reading or determine that there is insufficient calibration data. Adjusted readings are passed on to the consumers of the data (the application that indirectly use the sensors). If there is insufficient data, however, the location of the sensor is read from the localization system and the mobile robotic service unit 20 is deployed to this location (via path 50). After the calibrated sensor 22 on the mobile robotic service unit has had time to acclimate, the robots sensor and the uncalibrated sensor are read and this mapping is written to the calibration database. The algorithms are then re-consulted and the cycle repeats until an adjusted sensor reading is produced.

As will be appreciated, the computer system 30 and information processing centers respectively associated with the sensor platforms and mobile robotic service unit, include, but are not limited or restricted to a computer (e.g., desktop, a laptop, a server, blade server, a workstation, a personal digital assistant, embedded processing unit, etc.) or any peripherals associated therewith; communication equipment (e.g., telephone handset, pager, etc.); a television set-top box and the like. Furthermore, “connection” or “link” is broadly defined as a logical or physical communication path such as, for instance, electrical wire, optical fiber, cable, bus trace, or even a wireless channel using infrared, radio frequency (RF), or any other wireless signaling mechanism. In addition, the term “information” is defined as one or more bits of data, address, and/or control. “Code” includes software or firm-ware that, when executed, performs certain functions. Examples of code include an application, an applet, boot code, or any other series of instructions.

Software implementing the methods of system 10 can be stored in the memory of a computer system as a set of instructions to be executed. In addition, the instructions to perform the method and system as described above could alternatively be stored on other forms of machine-readable media, including magnetic and optical disks. For example, the method of the present invention could be stored on machine-readable media, such as flash memory, magnetic disks, or optical disks are accessible via a disk drive (or computer-readable medium drive). Further, the instructions can be downloaded into a computing device over a data network in a form of an executable version for self-installation.

Alternatively, the logic to perform the methods and systems as discussed above, could be implemented in additional computer and/or machine readable media, such as discrete hardware components as large-scale integrated circuits (LSI's), application-specific integrated circuits (ASIC's), or firmware such as electrically erasable programmable read-only memory (EEPROM's); or spatially distant computers relaying information through electrical, optical, acoustical and other forms of propagated signals (e.g., radio waves or infrared optical signals).

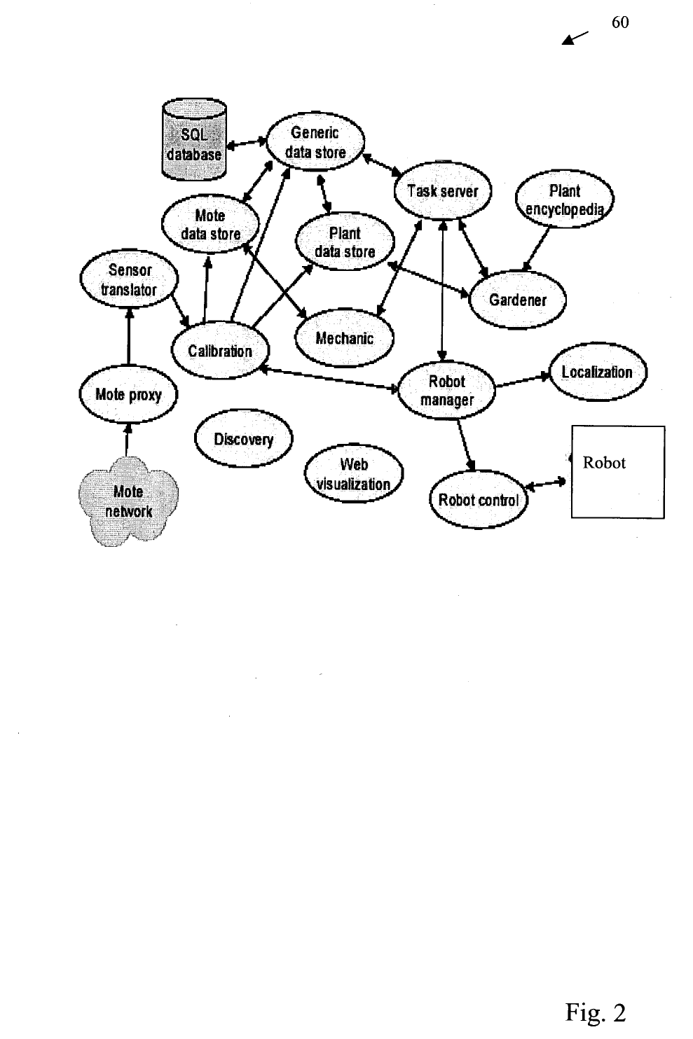

The details of the software system may be better understood with reference to FIG. 2, which schematically illustrates (diagram 60) functionality of a sensor/robot monitoring system and various supported operational software service modules. In one example of an embodiment of a system, a “PlantCare” software controlled system was constructed to explore issues associated with deployment of a zero-configuration and distraction-free system for the automatic care of houseplants. Each plant in a designated environment was provided with a wireless sensor placed in its pot and serviced by a robot that delivered water to the plants. The PlantCare application is composed of fifteen software service modules that collectively provide both the high-level application logic as well as the low-level driver-like code that communicates with hardware and external software. Service can independently receive data from the sensor base stations, unpack the data from its proprietary form, calibrate the data reading based on previously collected calibration data, and store the readings for future use by applications. The software services pertaining to the robot consist of a low-level service that knows how to activate the robot's sensors and actuators, and a high-level service that encapsulates the understanding of application-specific robotic tasks such as watering plants and delivering power to the motes.

For example, as seen with respect to FIG. 2, the software services include the following components:

Mote Proxy—The Mote Proxy serves as the bridge from the mote network to our service cloud. The mote proxy listens to the data-port which the Mote base-station is connected to and generates a mote-packet event for every packet it receives.

Sensor Translator—This service understands the format of the plant-care specific packets being sent on our mote network. Specifically it knows how to extract the reading for the mote's battery strength and the plants humidity, light and temperature readings. It consumes mote-packet events and generates plant-status and mote-status events.

Generic data-store—This is a general purpose data storage service built on top of an SQL database. This service takes SQL commands in the form of SQL-command events and produces the corresponding SQL-results events.

Mote data-store—This service presents an interface for storing and querying over the status of the motes. This service is stateless and simply translates the mote status events into SQL events which are sent to the generic data-store. This service takes mote-status, mote-status-query and SQL-results events. It produces SQL-command and mote-status-query-result events.

Plant data-store—This service is similar to the mote data-store, except that it traffics in plant status rather than mote status. It consumes plant-status, plant-status-query and SQL-results events. It produces SQL-command and plant-status-query-result events.

Plant encyclopedia—This service is a source of care information about a specific type of plant. It listens for plant-care-request events and responds with plant-care-information events.

Gardener—The gardener service is the heart of the plant-care portion of the application. It periodically wakes up and checks the plant data-store for plants that requite watering or other care. It gets specific care instructions from the plant encyclopedia. If it finds that a plant is in need of care, it issues plant-care instructions to the robot manager. This service consumes plant-status-query-result and plant-care-information events, and generates plant-status-query, plant-care-request and plant-care-instruction events.

Mechanic—The mechanic is responsible for making sure that the motes in the plant do not run out of energy. It ensures this by monitoring their status in the mote data-store and issuing requests for the robot to change the motes. This service is similar in structure to the Gardener. It consumes mote-status-query-result events and generates mote-status-query and mote-charging-instruction events.

Localization stack—This service provides information about the physical location of objects in the system, in this case the plants and the robot. This service receives request-for-location events and responds with location events.

Robot manager—The robot manager receives and prioritizes tasks for the robot to perform and transmits them to the robot. Currently this service provides no direct feedback on how well the robot is performing. This service takes mote-charging-instruction, plant-care-instruction and location events and produces request-for-location events.

In the embodiment of FIG. 2, the foregoing Rain messaging services are used to provide sensor calibration services. Because of the substantial available data processing power and data storage capacity of the system 60, quite complex calibration services can be provided. Based on long term software monitoring of data from the sensors, calibration services initially are used to derive the function that translates the raw readings provided by the sensor into data in the correct units, while taking into account the characteristics of the particular sensor and the environment in which it has been placed. Calibration of sensors is critical to obtaining accurate measurements. Without calibration, readings produced by a sensor could range anywhere from having subtle inaccuracies to being completely meaningless. Temperature sensors, for example, produce a voltage varying from 0 to 3 volts. The only way to know that a reading of 1.5 v corresponds to 32 degrees Celsius is to obtain a number of readings from the sensor when the true temperature is known and use these calibration points to translate the voltage readings to the Celsius scale. Unfortunately, this mapping varies from sensor to sensor (especially as manufacturers endeavor to make sensors as low-cost as possible) and may even change over the lifetime of a deployed sensor (due to changes in environmental conditions or wear on the sensor). The result is that for most applications, sensors require both initial calibration and periodic recalibration to ensure accurate readings.

Sensors can be calibrated either before or after deployment. Pre-deployment calibration is performed in a controlled space in which the environmental factor measured by the sensor can be carefully regulated. The factor is then cycled through a set of values intended to represent the range the sensor will encounter in practice, and readings are taken from the sensor during this process. These actual vs. sensed values form the set of calibration data that can be used to derive a function that maps one to the other. For example, linear regression is a simple yet accurate technique for performing this mapping. In the event that the sensor data cannot be mapped into linear space, mote complex algorithms can be employed. The big advantage of pre-deployment calibration is that it can be inexpensive, as a large number of sensors can often be calibrated at the same time. The disadvantage is that sensors are often sensitive to environmental conditions (e.g., temperature) and the act of deployment can change their characteristics. The alternative is to calibrate the sensor in-place, after it has been installed, using a robot equipped with an accurate, calibrated sensor offers a novel solution: adaptive in-place calibration. Given robotic support, a sensor can be deployed uncalibrated and a robot can be used to visit the sensor periodically to take calibration readings. As long as sensor readings remain in the range of these initial calibration readings, no additional visits are required. However, if environmental factors deviate outside the calibrated range, the robot can be dispatched to collect additional readings. For example, consider a wireless temperature sensor in an unheated warehouse. The sensor is deployed uncalibrated during the summer. Over a period of five days, the robot collects a set of calibration readings. These readings combined with simple regression provide sufficient accuracy for the next three months. When fall sets in, the temperature drops, and the system determines that the summer calibration data is not sufficient to predict the characteristics of the sensor. The robot is then re-deployed to collect new calibration samples to extend the range of the regression model.

Recalibration is another area in which a robotic solution offers advantages over the standard technique. If calibration data is a task performed once or twice a year, recalibration becomes an ever-present background task of the system. Once the lifetime of a piece of calibration data has expired, it is considered inaccurate and is replaced by fresh data. The result is an adaptive mechanism in which the tradeoff of sensor accuracy vs. robotic work can be adjusted at will.

Detecting a failed sensor is the pathological case of calibration when it is decided that the sensor readings no longer correlate with the environmental factor in question. This detection is fairly straightforward in the case of a gross fault, in which a sensor begins reporting drastically different conditions. Regular periodic calibration by our robotic solution also removes the traditional need to detect drift errors, in which a sensor's accuracy slowly decays over time. Without sophisticated models, however, it is very difficult to detect when a faulty sensor returns plausible, possibly varying, yet uncorrelated data. Because sensors are only checked periodically, faulty sensors can remain in service for periods up to the calibration frequency. Depending on the scenario in which the sensors are used, this could pose severe consequences. To mitigate this, the calibration cycle can be made more frequent by using a smaller calibration data lifetime.

Inferential sensing is an emerging technique that continuously verifies sensor accuracy via on-line, real-time modeling. This technique uses historical data rather than sensor redundancy to construct predictive models of sensor behavior and can significantly enhance system fault detection and handling. Whenever a sensor provides a reading, the data is compared to estimated values produced by the model, generating differences known as residuals. A decision logic module then statistically evaluates each residual to generate a health metric assigned to the corresponding sensor. Instead of performing periodic recalibration, a human operator monitors these health metrics in order to schedule maintenance proactively or provide it when necessary. Unlike simpler methods, this approach can detect sensors that fail in non-trivial ways. In addition, these predictive models can be used to generate estimated sensor readings while a sensor is offline or awaiting recalibration or replacement. In the case of sensor failure, the predictive model can serve as warning system and the robot can verify the failure. When the predictive model suspects a sensor of drifting, it can prematurely age the sensor's calibration data, forcing a more timely robotic recalibration.

In operation, intercommunication between the foregoing software service modules of FIG. 2 primarily relies on a lightweight XML-based messaging known as “RAIN” developed at the Intel Research Seattle. Rain uses both “Services” and “Messages” to mediate control of mobile and fixed unit of the system 60. Services represent the computational components of the system and they communicate via messages. In Rain, messages are pieces of XML and as such, allow services to interact using semi-structured data. In Rain, message delivery is generally asynchronous, although it can be configured for synchronous delivery if desired. The message is not guaranteed to have been delivered by the time the send method returns. When the message does arrive at the destination service, a thread is taken from the thread pool and the destination service's process method is called with the message.

For example, one Rain service sends another a message as follows:

Message m=new Message(this);

m.setRecipient(friendlyService);

m.addElement(new Element(“Hi”));

m.send( );

Services in Rain find each other via a special Rain service called the discovery service. Services in Rain interact with the discovery service in two ways. First, they send the discovery service their own unique id (called a ServiceID) and their advertisement. In Rain, an advertisement is a piece of XML that can contain any semi-structured data the service wants. Second, services in Rain can query the discovery service using xpath queries to find other services.

Rain is implemented in Java, and include but is not limited to the following class package:

Continuation

ContinuationHandler

DiscoveryClient

DiscoveryRequest

DiscoveryService

Dispatcher

Element

GUID

HaltHandlingException

HtmlUI

Message

MessageHandler

ParseException

RainException

RainServlet

Service

ServiceID

Transport

In more detail, some of the foregoing class packages have the following attributes:

public class Continuation

extends Object

This class provides a mechanism to continue a computation after a reply to a message has arrived. This works by associating a continuation with an outbound message using the associate method. When a reply to this message arrives, the service call the invoke method on the continuation object. If the continuation was constructed with a timeout and a reply does not arrive within that time, the timeout method will be called. While this class is not abstract, it does very little of interest until either invoke, timeout or both are overridden. By default, continuations are “single shot”. This means that once a reply has been received, the continuation is removed from the continuation system. To create a continuation that can be invoked multiple times, call setMultiShot with true. (Multi-shot continuations are useful in situations where multiple replies may come back for a single sent message.) Note that a multi-shot continuation with no timeout won't ever expire, so removal with the delete method is required.

public class ContinuationHandler

extends Object

implements MessageHandler

This handler is responsible for checking incoming messages to see if its continuation-id matches any registered continuations. This handler is installed in all services by default.

public class Dispatcher

extends Object

This class implements the handling of inbound and outbound messages for a service, and each service has a dispatcher. (Services can get their dispatcher using the Service.getDispatcher( ) method). On the inbound path, messages are handed to each “filter” one at a time, in sorted order from highest to lowest. After all the filters have handled the message, a “handler” with a message-type matching the message will be given the message. If none match, the service's default handler is invoked. For outbound messages, the outbound filters are all shown the message in descending order. If any of the filters throws a HaltProcessing exception, the processing of the message will be stopped.

The Dispatcher class constrains methods for adding, ordering and removing inbound and outbound filters and typed handlers.

public class DiscoveryRequest

extends Message

This class extends Message with static methods to pre-fill messages in the format expected by the discovery service. This class makes asynchronous communication with discovery easier. For synchronous discovery access, use the DiscoveryClient class.

public class Element

extends Object

An element of an XML tree

public class HtmlUI

extends Object

implements MessageHandler

The basic Rain infrastructure includes a simple HTML interface to allow services to make simple CGI interfaces. This class provides a default message handler which can be extended to customize a service's behavior in a webserver.

public class Message

extends Element

Message are the core unit of communication between Rain services. Since Rain communication uses XML, Message is a subclass of Element. Message in Rain are very non-structured and there are only two restrictions: First, each message needs to have exactly one direct child element called sender which contains the ServiceID of the sender. Second, the message also needs a singleton child called recipient containing the ServiceID of the recipient of the message.

To communicate with a remote service, the local service constructs a message passing itself in as the sender. It then assigns the message a recipient. The service can then add whatever content it wants to the message using the standard methods of an Element. Finally the message is send using the send method.

An alternative to constructing a Message object is to use the static send method. This is useful for sending simple replies and acknowledgements.

public class Service

extends Object

implements MessageHandler

Services are the core component of the Rain system. Services communicate with each other via Messages.

All services in Rain have a unique ServiceID assigned to them on creation and this ServiceID is used to address messages. Creating a service implicitly starts up the rain infrastructure, so Services are the entry point to the system. Services can advertise themselves via discovery using a setDescription method. When a service is finished, it may withdraw from Rain using the withdraw( ) method.

The routing of a Service's messages is handled by the Dispatcher.

public class ServiceID

extends Object

A serviceID encapsulates the unique identifier of the service instance the ServiceID belongs to. In general ServiceIDs are used as opaque types to address message. In practice ServiceIDs are made of two parts, a URL and a unique identifier. (Usually a GUID). The Rain system used the URL to locate a Rain node, and the node used the GUID to identify the local service.

As will be appreciated, various modifications to the classes, functionality, and features of the foregoing classes are possible.

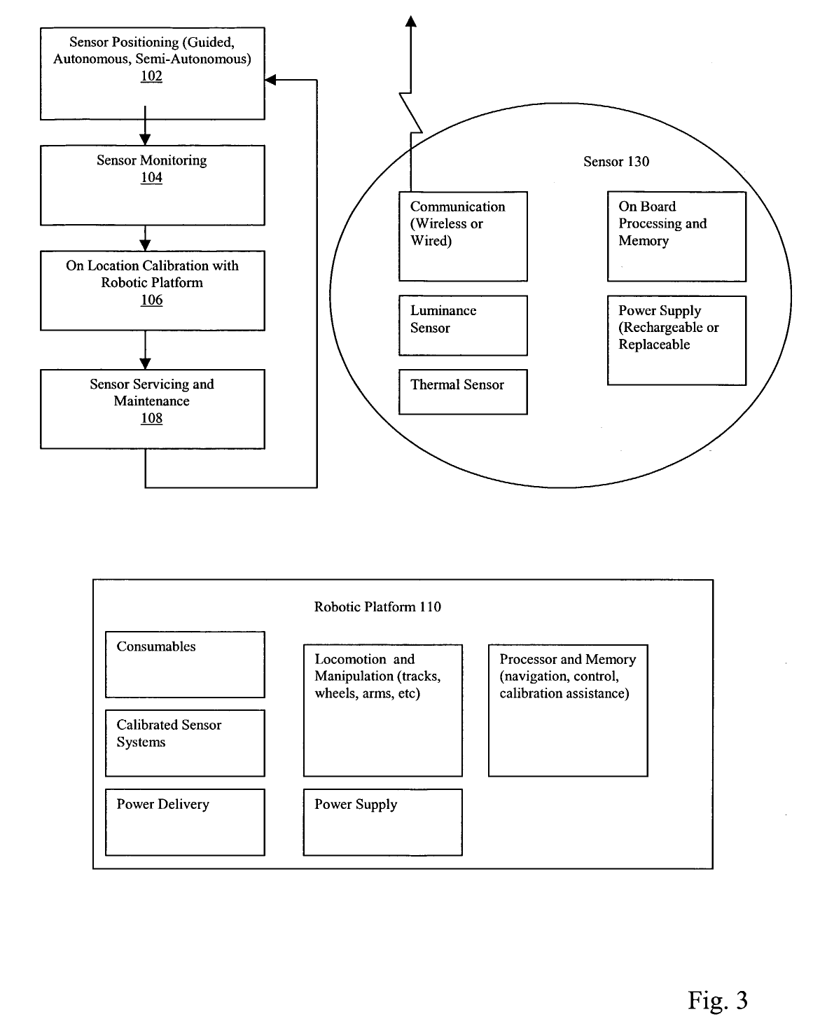

The details of the mobile robotic service unit controlled by the foregoing described software control and calibration system may be better understood with reference to FIG. 3, which schematically illustrates functionality of a sensor/robot monitoring system and various supported operational modules of a robotic platform 110 (corresponding to mobile robotic service unit 20 and its sensor 22 of FIG. 1) suitable for servicing such a system. As seen in FIG. 3, a robotic platform 110 that can include facilities for locomotion and manipulation; on-board processing and memory for navigation, control, calibration assistance; and a power supply. Other onboard systems that directly affect sensor operation can include consumables (e.g. water, replacement sensor cartridges, etc), power delivery to the sensor platform (e.g. battery replacement, inductive or direct recharging, etc), and the onboard calibration sensor to provide. In operation, the robotic platform 110 typically allow for sensor positioning 102, sensor monitoring 104, on location calibration 106, and sensor servicing and maintenance 108.

As seen in FIG. 3, the sensor platform can include a sensor 130 that communicates data through a wireless or wired data link to the robot or another computer system, and contains one or more calibrated sensors (e.g. a luminance sensor, thermal sensor, etc.) The sensor can also have some limited processing and memory functionality, allowing for initial data processing and compression that reduces communication bandwidth requirements for sensor data monitoring. The sensor 130 can use long life batteries (e.g. lithium batteries), be hardwired into a suitable house current or low voltage electrical system, or be capable of having its batteries replaced or recharged (by direct current or inductive recharging.

In the previously described PlantCare system, wireless sensor nodes are placed both on the robot and in the immediate vicinity of selected plants. The sensors in the plants provided a continuous stream of data reflecting their state while the sensor node on the robot is used to calibrate the sensors. While the sensors in the plants and on the robot vary slightly, the wireless nodes are identical. PlantCare's sensors are built as a “mote” sensor platform operating at 3V and assembled from off-the-shelf components that include an 8-bit microcontroller, a two-way 916 MHz radio for communication, and an expansion connector that facilitates connection of environmental sensors. TinyOS, a small, real-time, modular operating system that supports ad-hoc networking to allow motes to communicate both with each other and with a base station is used in the sensor platforms. Environment sensing hardware consisted of a photo-resistor for measuring light levels, a thermistor for measuring temperature, an irrometer for measuring soil moisture content, and a sensor that monitors the current charge of the power source. In addition, the sensor nodes in our plants were augmented with a custom power system in which capacitors replace traditional batteries and can be recharged using an inductive coil to support power delivery.

The wireless network contains a single base station mote, which by virtue of being attached to the serial port of an Internet-connected PC served as the physical link between the wireless sensor network and the PlantCare services. The base station listened to the sensor network for messages containing sensor readings and forwarded these messages to the serial port. The robot hardware platform included a Pioneer 2-DX mobile robot augmented with custom hardware for watering plants, recharging the robot, recharging remote sensors, and sensing environmental conditions for calibration purposes. To deliver water to the plants, the robot was fitted with a small water tank, dispensing spout, and pump. To deliver power to wireless sensors an inductive charging coil was positioned near the watering spout. Similarly, another paddle-shaped inductive charge coil was added to the robot to allow it to recharge itself In order to support sensor calibration services, the robot included a sensor node that was human-calibrated. Finally, a small microcontroller board allowed software on the robot to both control and read the state of this collection of custom hardware. Both this microcontroller and the laser scanner the robot uses for navigation were connected to a laptop that runs the robot's control and navigation algorithms and is in turn connected to the network via an IEEE 802.11b wireless card. Lastly, the robot has a maintenance bay it uses to automatically recharge its own batteries and refill its water reservoir. The bay has a water supply with a spout for dispensing water to the robot, and a charging system matched to the robot's paddle-shaped induction coil.

Inductive charging was used for both the sensors and the robot in order to reduce associated electrical dangers. The measured efficiency of inductively charging the sensors was around 70% of the baseline efficiency achieved with a shielded cable. This inefficiency reduced the amount of time the robot can function without recharging, thereby resulting in more frequent visits to the maintenance bay. The robot navigation system included a reactive collision avoidance module, a module for map building and path planning, and a localization module. All components used probabilistic methods to deal with uncertain sensor information.

As will be understood, alternative calibratable sensor systems that support sensor dissemination, retrieval, and calibration are particularly useful for hostile environments that are dangerous to personnel, too remote for frequent visits for manual service/calibration, or too small for easy access by personnel. Such environments may include those having high or low ambient temperatures, toxic atmospheres, high pressure, or involve exposure to hazardous biomaterials. For example, robotic calibration of emplaced chemical or biosensors in wells monitoring long term groundwater contamination may involve use of robotic arms or crawlers that are maneuvered down a well head for in site placement and calibration. In other embodiments, radiation sensors operable in high radiation zones can be calibrated.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Accordingly, it is the following claims including any amendments thereto that define the scope of the invention.

The claimed invention is:

1. A method comprising:
supporting sensor control services, robotic control services, and database management services on at least two independent software systems, with service availability being registerable between one or more services; and
communicating between the services via messages not guaranteed to be delivered.

2. The method of claim 1, wherein messages are XML based.

3. The method of claim 1, further comprising a send method for a first software system to send a message, and a receive method for a second software system.

4. The method of claim 1, further comprising utilization of multiple sensor control services, including a sensor calibration service and a sensor data store service.

5. The method of claim 1, further comprising utilization of multiple robotic control services, including a navigation service and a task service.

6. The method of claim 1, wherein the database management services further comprises linkage to a SQL database.

7. The method of claim 1, further comprising a watchdog service check to ensure service availability.

8. The method of claim 1, further comprising a meta-watchdog service check to ensure availability of a watchdog service.

9. The method of claim 1, wherein the sensor control services are stateless.

10. The method of claim 1, wherein the robotic control services are stateless.

11. An article comprising a storage medium having stored thereon instructions that when executed by a machine result in:
supporting sensor control services, robotic control services, and database management services on at least two independent software systems, with service availability being registerable between one or more services; and
communicating between the services via messages not guaranteed to be delivered.

12. The article comprising a storage medium having stored thereon instructions according to claim 11, wherein messages are XML based

13. The article comprising a storage medium having stored thereon instructions according to claim 11, further comprising a send method for a first software system to send a message, and a receive method for a second software system.

14. The article comprising a storage medium having stored thereon instructions according to claim 11, further comprising utilization of multiple sensor control services, including a sensor calibration service and a sensor data store service.

15. The article comprising a storage medium having stored thereon instructions according to claim 11, further comprising utilization of multiple robotic control services, including a navigation service and a task service.

16. The article comprising a storage medium having stored thereon instructions according to claim 11, wherein the database management services further comprises linkage to a SQL database.

17. The article comprising a storage medium having stored thereon instructions according to claim 11, further comprising a watchdog service check to ensure service! availability.

18. The article comprising a storage medium having stored thereon instructions according to claim 11, further comprising a meta-watchdog service check to ensure availability of a watchdog service.

19. The article comprising a storage medium having stored thereon instructions according to claim 11, wherein the sensor control services are stateless.

20. The article comprising a storage medium having stored thereon instructions according to claim 11, wherein the robotic control services are stateless.

21. A sensor monitoring system comprising:
a distributed software system supporting sensor control services, robotic control services, and database management services on at least two independent software systems, with service availability being registerable between one or more services; and
communicating between the services via messages not guaranteed to be delivered.

22. The sensor monitoring system of claim 21, wherein messages are XML based.

23. The sensor monitoring system of claim 21, further comprising a send method for a first software system to send a message, and a receive method for a second software system.

24. The sensor monitoring system of claim 21, further comprising utilization of multiple sensor control services, including a sensor calibration service and a sensor data store service.

25. The sensor monitoring system of claim 21, further comprising utilization of multiple robotic control services, including a navigation service and a task service.

26. The sensor monitoring system of claim 21, wherein the database management services further comprises linkage to a SQL database.

27. The sensor monitoring system of claim 21, further comprising a watchdog service check to ensure service availability.

28. The sensor monitoring system of claim 21, further comprising a meta-watchdog service check to ensure availability of a watchdog service.

29. The sensor monitoring system of claim 21, wherein the sensor control services are stateless.

30. The sensor monitoring system of claim 21, wherein the robotic control services are stateless.
